(19) United States
(12) Patent Application Publication
(10) Pub. No.: US 2024/0390874 A1
(43) Pub. Date: Nov. 28, 2024

(54) ORTHOGONAL FLOW CHEMISTRY MICROREACTOR FOR RAPID SCREENING

(71) Applicant: INTERNATIONAL BUSINESS MACHINES CORPORATION, ARMONK, NY (US)

(72) Inventor: Emanuel Marc Lörtscher, Hedingen (CH)

(21) Appl. No.: 18/323,589

(22) Filed: May 25, 2023

(51) Int. Cl. B01J 19/00

(52) U.S. Cl. CPC B01J 19/0093; B01J 19/0046; B01J 2208/00628

(57) ABSTRACT

According to aspects, the invention is embodied as a method of performing chemical reaction screening steps using a microfluidic device, which includes a microreactor. The latter is defined at an intersection of a first channel and a second channel of the microfluidic device. The first channel is fenced by two size-selective filters, at the intersection. The two size-selective filters include a first filter and a second filter, which are respectively arranged upstream and downstream of the microreactor in the second channel. The method revolves around sequentially performing chemical reaction screening steps according to distinct combinations of pairs of chemical compounds, where each of the pairs involves a first chemical compound and a second chemical compound. Beads are fed into the microreactor and a solution is flown through the microreactor. The beads are fed into the microreactor through the first channel, such that they remain confined between the two size-selective filters.

### BACKGROUND

The invention relates in general to the field of chemistry, and more particularly to performing chemical reaction screening steps.

Chemical reactions are fundamental to life. For example, they play a critical role in the metabolism of living organisms, photosynthesis, and chemical production of various products such as fertilizers and drugs.

Catalytic reactions are an important class of chemical reactions. Catalytic reactions involve a starting material (also referred to as a “substrate”), which reacts with a catalyst to yield a new chemical compound as the substrate undergoes a chemical conversion, namely a modification of its chemical structure, due to the catalyst. The catalyst is not consumed by the reaction and remains unchanged by it. The presence of the catalyst can drastically enhance the reaction rate or even trigger the reaction. In fact, catalysis are involved in approximately 90% of all commercially produced chemicals, making it an essential part of many industrial processes. Still, there are reasons to believe that a vast number of catalytic reactions have not been discovered yet given the large number of potential combinations and the ever-expanding chemical space.

Catalysis can be classified into two main types: homogeneous catalysis, in which all components are present in the same phase (e.g., a liquid phase), and heterogeneous catalysis, in which the components are in different phases (e.g., liquid and solid). While homogeneous catalysis can be performed with little effort in wet chemistry environments (e.g., using batch synthesis), labor-intensive techniques are subsequently required to separate the compounds after the reaction took place. In heterogeneous catalysis, on the contrary, macroscopic systems exist, were one reaction partner-mostly the catalyst-remains stationary inside a reaction compartment, e.g., a flow-chemistry microreactor. This is due to catalysts being provided as macroscopic solids, or embedded into tubes or pellets, which are then withheld by various hierarchical filtering structures (including membranes or meshes) or immobilized on carrier materials. The substrate is passed through the microreactor. Because catalysts remain inside the microreactor, heterogeneous catalysis reactions can be performed without having to separate the chemical components. Examples of such flow-chemistry approaches include packed-bed, trickled-bed, bubble-flow, or wall-coated microreactors. Yields are close to 100% in optimized microreactors, meaning that almost all of the substrate molecules are converted into the reaction products, while only a very little part of the substrates leaves the microreactor unaltered.

Such microreactors are adequate for performing well-established, repetitive reactions and are thus widely used in industry. However, such microreactors are not designed to allow the catalyst material to be quickly exchanged, e.g., to conduct reaction pathway screening.

### SUMMARY

According to a first aspect, the present invention is embodied as a method of performing chemical reaction screening steps. The method relies on a microfluidic device, which includes a microreactor. The latter is defined at an intersection of a first channel and a second channel of the microfluidic device. The first channel is fenced by two size-selective filters, at the intersection. The two size-selective filters include a first filter and a second filter, which are respectively arranged upstream and downstream of the microreactor in the second channel.

The method revolves around sequentially performing chemical reaction screening steps according to distinct combinations of pairs of chemical compounds, where each of the pairs involves a first chemical compound (e.g., a catalyst) and a second chemical compound. Each chemical reaction screening step is performed as follows.

Beads are fed into the microreactor. A solution is flown through the microreactor. The beads are fed into the microreactor through the first channel, such that they remain confined between the two size-selective filters. The beads are functionalized with, or consist of, the first chemical compound of one of the pairs. The average diameter of the beads is preferably between 50 nm and 100 μm. The distinct combinations of pairs of chemical compounds may for instance differ in one or more of: a type of the first chemical compound, a type of the second chemical compound, and a concentration of the first chemical compound (e.g., a catalyst load).

The solution contains the second chemical compound of one of the pairs. It is flown along the second channel, upstream of the microreactor, for the second chemical compound to pass through the first filter and chemically interact with the first chemical compound in the microreactor, to yield a reaction product that is eventually flushed through the second filter. The volume of the microreactor through which the solution is flown at each chemical screening step is preferably less than 5 μl.

In embodiments, the first chemical compound includes a catalyst, for each of at least some of the distinct combinations of pairs of chemical compounds. In that case, the solution flown along the second channel gives rise to a chemical reaction involving the second chemical compound as a reactant. The chemical reaction is catalyzed by the catalyst upon the second chemical compound interacting with the catalyst in the microreactor.

In embodiments, at least some of the chemical reaction screening steps are repeatedly performed under different experimental conditions applied to the microreactor. In variants, or in addition, different experimental conditions may be applied to the first chemical compounds in the first channel, i.e., prior to entering the microreactor. Similarly, different experimental conditions may be applied to the second chemical compounds in the second channel, prior to flowing the second compound through the microreactor.

The present methods rely on a size differentiation between the first compounds (e.g., catalysts) and the second compounds (substrates) by immobilizing the first compound onto beads or forming large aggregates (i.e., beads) of the first compounds. The resulting beads are sufficiently large objects, which cannot pass through the filters. Thus, the present approach is particularly suitable for efficiently delivering and removing test chemical compounds (e.g., catalysts) into the chemical reaction compartment formed by the microreactor. In turns, this makes it possible to react test compounds efficiently and systematically with probe compounds (the first compounds) flown through the microreactor. In particular, the proposed approach allows an automated catalyst feed and removal to be achieved, which enables rapid, scalable, multiplexed, and combinatorial screening of reaction pathways, in which substrates, catalysts, and conditions can be altered with little experimental effort. Remarkably, very small amounts of the first compound (e.g., a catalysts) suffice, which can possibly be reused, making the approach fully compatible with typical research-scale quantities. Such a screening method can advantageously be used in various applications involving chemical synthesis, including drug discovery, production of fertilizers and pharmaceutics, as well as material discovery.

In embodiments, the first channel is only fenced by the two size-selective filters. In variants, the first channel is further fenced, at the intersection, by a third size-selective filter, which is arranged in the first channel on one side of the microreactor, so as to prevent the loaded beads from exiting the microreactor through the first channel on said one side. The beads are loaded, at each chemical screening step, from another side of the microreactor, opposite to said one side. Each chemical screening step further comprises, after flowing the solution to obtain the reaction product, removing the confined beads by flowing a solution along the first channel, e.g., by flushing a rinsing solution from said another side of the microreactor or by aspirating the liquid that is already present in the channel. In both cases, a solution flows through the third size-selective filter and flushes the beads in the first channel on said one side, e.g., to another compartment or a channel portion, where they can be collected, and recycled or stored for a later use.

In embodiments, the method further comprises, prior to performing the chemical reaction screening steps, piling up distinct batches of beads in the first channel, with a view to successively feeding the batches into the microreactor to perform said chemical reaction screening steps.

In embodiments, the chemical reaction screening steps are sequentially performed by repeatedly using at least one of the batches of beads.

In embodiments, sequentially performing the chemical reaction screening steps further comprises changing a type of solution to be flown along the second channel, and reversing a direction according to which batches are fed into the microreactor through the first channel.

In embodiments, piling up the distinct batches of beads comprises intercalating batches of spacer beads between the distinct batches in the first channel, whereby one batch of spacer beads separates (i.e., demarcates) two successive ones of the distinct heaps of the of distinctly functionalized beads on each side of said one batch.

In embodiments, at least some of the beads have a detectable electromagnetic property. In that case, feeding the beads into the microreactor further comprises moving the beads and detecting, while moving the beads, the electromagnetic property of at least some of the beads that are in a vicinity of the microreactor. The step of feeding the beads further comprises adjusting a position of one of the distinct batches of beads in the microreactor based on the detected electromagnetic property.

In embodiments, the distinct batches of beads are piled up so as to have constant segment lengths in the first channel, subject to a relative standard deviation of less than 5%.

In embodiments, each chemical screening step further comprises collecting the reaction product in the first channel, downstream of the microreactor.

In embodiments, each chemical screening step further comprises characterizing one or more properties of the reaction product.

According to another aspect, the invention is embodied as a system for performing chemical reaction screening steps, wherein the system comprises a microfluidic device, a bead supply, and a solution supply. The microfluidic device includes a first channel, a second channel, and a microreactor defined at an intersection of the first channel and the second channel. The first channel is fenced at the intersection by two size-selective filters. These include a first filter and a second filter, which are respectively arranged upstream and downstream of the microreactor in the second channel. The bead supply is connectable to the first channel. The bead supply stores distinct batches of beads that are functionalized with, or consist of, first chemical compounds, the distinct batches corresponding to distinct ones of the first chemical compounds. The beads are dimensioned to be confined between the two size-selective filters if loaded into the microreactor. The solution supply is connectable to the second channel; the solution supply stores one or more solutions respectively containing one or more second chemical compounds.

In embodiments, each of the two size-selective filters comprise structures, such as posts, which extend across the second channel, transversely to a flow direction along the second channel. The structures define openings. A minimal dimension of the openings is substantially less than an average diameter of the beads of any of the batches, so as to efficiently confine the beads, in operation.

In embodiments, the size-selective filters and the microreactor are configured so that the batches of beads can be successively fed into the microreactor and removed from the microreactor by translating the batches of beads along a same direction along the first channel, in operation.

In embodiments, the first channel is further fenced, at the intersection, by a third size-selective filter, which is arranged on one side of the microreactor in the first channel.

In embodiments, the bead supply comprises an auxiliary microfluidic device, which includes a plurality of loading channels that are selectively connectable to the first channel. Each loading channel of the loading channels is fenced by a respective size-selective filter to hold a respective batch of beads in said each loading channel.

In embodiments, the system further comprises a first selector valve, which itself includes selectable ports. The selectable ports include an input port and a plurality of loading ports. The loading ports are connected to respective ones of the loading channels. The first selector valve is configured to controllably connect the first channel to any of the selectable ports. This makes it possible to enable various flow paths and, in particular, to preload batches of beads and then load them in the microreactor through the first channel.

In embodiments, the system further comprises a second selector valve, itself including a plurality of second ports. The second ports include a second input port as well as unloading ports, which are connected to respective ones of the loading channels. The second selector valve is configured to controllably connect the second input port to either one of the loading channels. This makes it possible to flow a liquid (e.g., a solution) in any of the channels (as connected according to a setting of the first and second selector valves), either in a forward or backward direction. This way, it is possible to simply control all necessary liquid flows, e.g., using mere syringes.

In embodiments, the system further comprises a control system and a collector, the latter arranged downstream of the microreactor. The control system is operatively connected to the collector to actuate the latter, for the collector to collect a reaction product in the second channel, downstream of the microreactor, in operation of the system. The collected product can then be analyzed offline, using any suitable characterization method

In preferred embodiments, the system further comprises a control system and a characterization apparatus. The control system is operatively connected to the characterization apparatus to control the latter, for the characterization apparatus to characterize one or more properties of a reaction product in the first channel, downstream of the microreactor, in operation of the system. The characterization apparatus may possibly be configured to feedback-control the reaction conditions. The system may possibly include both a collector and a characterization apparatus. In that case, the characterization apparatus is used to characterize products (i.e., samples) as collected by the collector, in operation.

In embodiments, the system further comprises a control system and a detector, the latter arranged so as to detect an electromagnetic property of at least some of the beads in the first channel, in operation. The control system is operatively connected to the detector for it to detect said electromagnetic property and generate a corresponding control signal, which makes it possible to more accurately control the positions of the batches loaded in the microreactor.

### BRIEF DESCRIPTION OF THE DRAWINGS

These and other objects, features, and advantages of the present invention will become apparent from the following detailed description of illustrative embodiments thereof, which is to be read in connection with the accompanying drawings. The illustrations are for clarity in facilitating one skilled in the art in understanding the invention in conjunction with the detailed description. In the drawings:

FIG. 1 schematically illustrates selected components of a first embodiment of a system for performing chemical reaction screening steps. The system includes a microfluidic device, in which a microreactor is served by two transverse channels. The system further includes a bead supply, a solution supply, and a control system, to allow distinct batches of beads to be linearly fed into the microreactor through one of the two transverse channels, as also illustrated in FIG. 3;

FIGS. 2A (top view), 2B (3D view), and 2C (side view), schematically illustrate the microfluidic device of the system shown in FIG. 1, where the microreactor is fenced by only two opposite size-selective filters, as in embodiments;

FIG. 3 illustrates how the microreactor of the system of FIG. 1 is operated to sequentially perform chemical reaction screening steps according to distinct combinations of pairs of chemical compounds, as in embodiments;

FIG. 4 is a simplified diagram representation of FIG. 3;

FIG. 5 is a diagram illustrating how chemical reaction screening steps can be sequentially performed thanks to cascaded microfluidic devices, as in embodiments;

FIGS. 6A and 6B schematically illustrate selected components of a second embodiment of a system for performing chemical reaction screening steps. As in FIG. 1, the system includes a microfluidic device, in which a microreactor is served by two transverse channels. However, the microreactor is now fenced by a further size-selective filter, holding the beads loaded in the microreactor. Batches of beads are selectively fed from an auxiliary microfluidic device, which stores the distinct batches of beads in respective loading channels. The liquid flows are controlled through syringes; and

FIG. 7 is a flowchart illustrating high-level steps of a method of operating a system such as illustrated in FIG. 1 or 6A, according to embodiments.

The accompanying drawings show simplified representations of devices or parts thereof, as involved in embodiments. Technical features depicted in the drawings are not necessarily to scale. Similar or functionally similar elements in the figures have been allocated the same numeral references, unless otherwise indicated.

Systems and methods embodying the present invention will now be described, by way of non-limiting examples.

### DETAILED DESCRIPTION OF EMBODIMENTS OF THE INVENTION

As explained earlier, the chemical microreactors described in the background section are adequate for performing well-established reactions and are thus widely used in industry.

However, such microreactors are not designed to allow the catalyst material to be quickly exchanged. They are not designed to handle very small amounts of materials either. Exchanging the catalyst material in such microreactors is time-consuming and labor intensive, because the microreactor must first be opened, and the catalyst materials can only be exchanged after having removed all the filtering components of the microreactor stack. As the present inventors concluded, such microreactors are not suited for exploration of new catalysis pathways where substrates must be repeatedly put into interactions with different types of catalysts or different sequences of catalysts.

Now, in today's chemistry, there is a need to test chemical interaction affinities between a variety of existing or new compounds (e.g., new catalyst materials and existing substrates, new substrates and existing catalysts, or new substrates and new catalysts), while new chemical compounds are being developed on a daily basis.

Accelerated material discovery makes use of artificial intelligence to predict new chemical compounds, catalytic moieties, and overall compound reactivity. However, there is still a need for experimental verification, and in particular what affects the optimization of reaction conditions and yields. Now, experimental validation procedures typically require a systematic testing of reaction conditions as kinetic rates depend strongly on a number of factors, e.g., compound mixing, compound concentrations, local temperature, pressure, etc. As the present inventors have concluded, such experimental validation procedures would most effectively be performed according to a systematic combinatorial process, which is unfortunately impractical with current microreactors.

Furthermore, for emerging classes of organocatalysts that are being developed in research, conventional (meso- and macroscale) heterogeneous catalysis microreactors are not compatible with reaction screening. The reason is that the amount of material needed for proper operation—both in terms of substrates and catalysts—is not compatible with synthesis production, where at most milligrams or sub-milligrams of compounds can be afforded.

While, on the other hand, certain microreactors can handle microscopic amounts of material, such microreactors are, so far, only designed for homogenous flow-chemistry operations, which requires separating compounds after each synthesis step. No approach was so far demonstrated—to the best knowledge of the inventors—for catalyst exchange operations in microreactors in general or for combinatorial screening of reaction pathways in particular.

This has led the inventors to develop new methods and systems for sequentially performing chemical reaction screening steps according to combinations of pairs of chemical compounds.

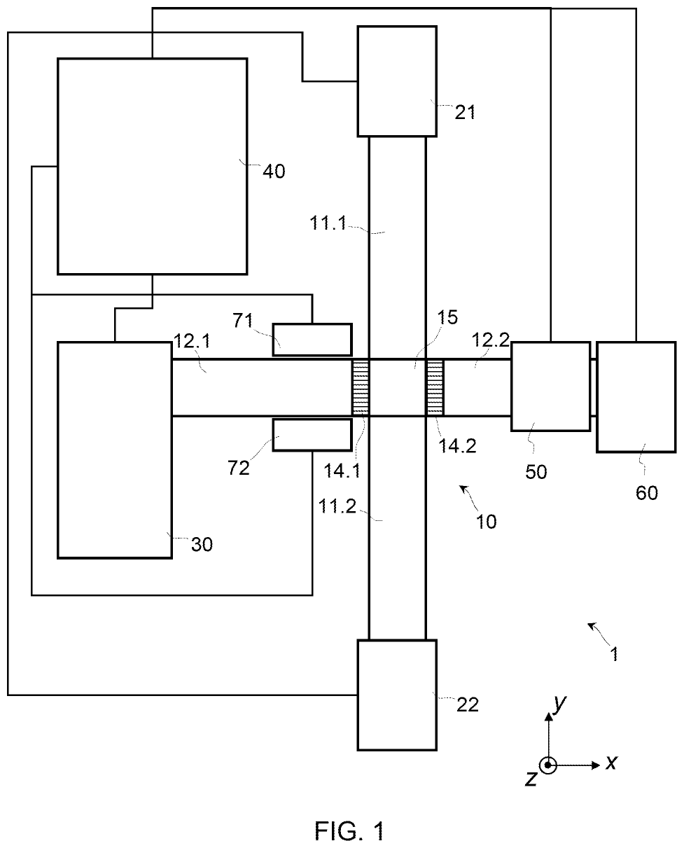

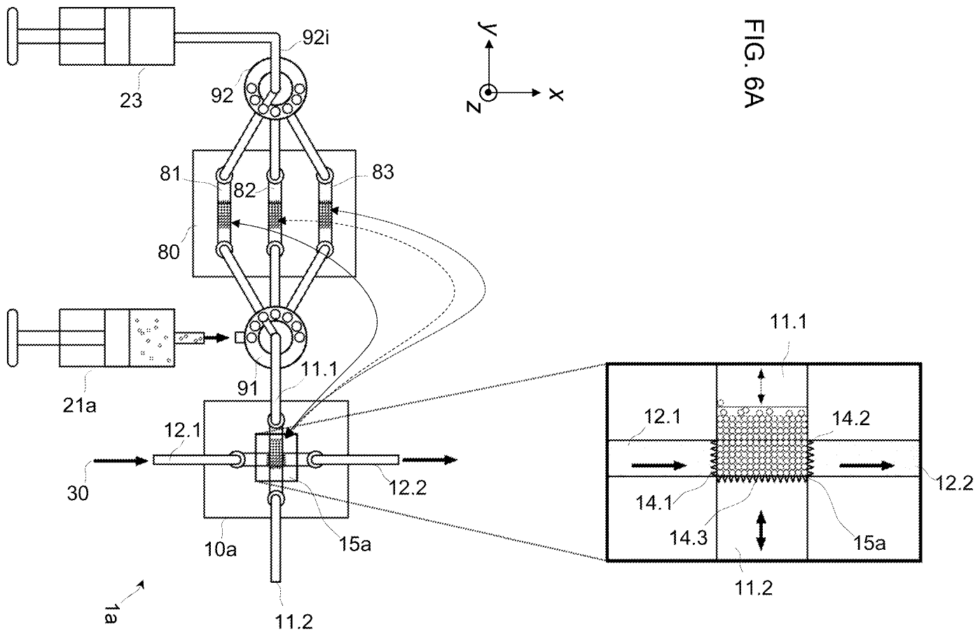

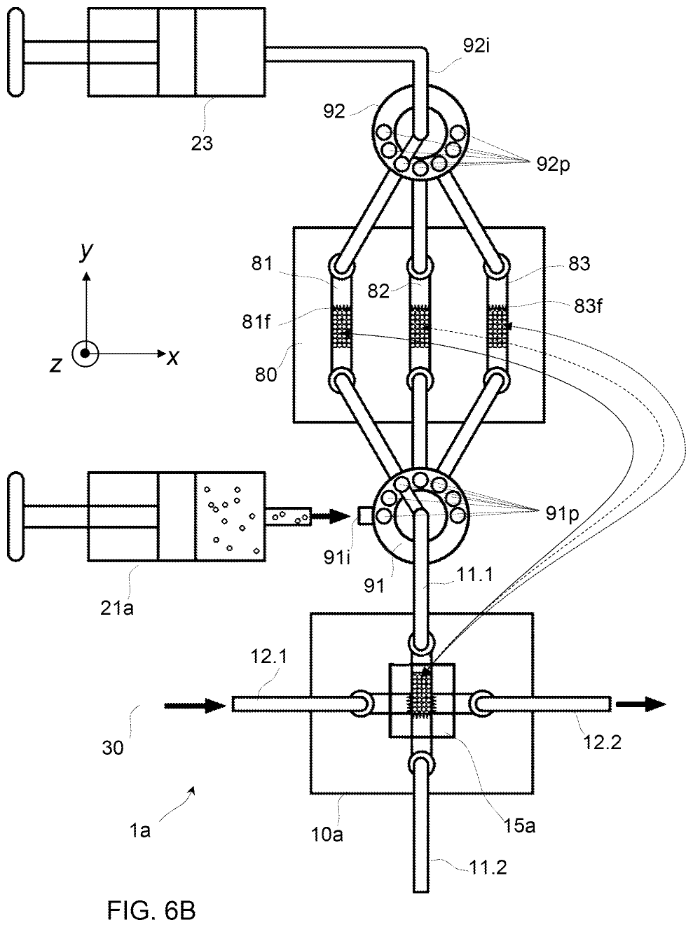

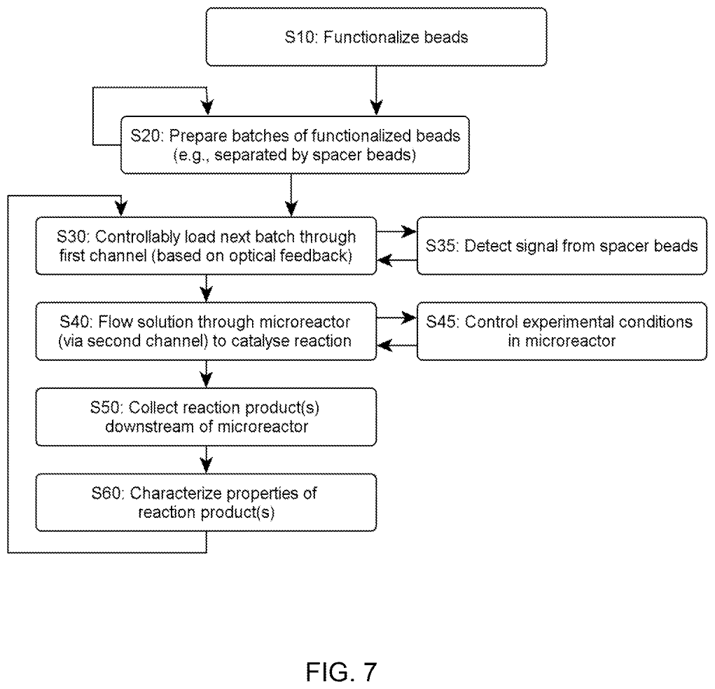

A first aspect of the invention is now described in detail in reference to FIGS. 1-7. This aspect concerns a method of performing chemical reaction screening steps. The method can be performed with a system such as depicted in FIG. 1 or 6A. Note, this method and its variants are sometimes collectively referred to as the “present methods”. All references Sn refer to methods steps of the flowcharts of FIG. 7, while numeral references and other symbols (e.g., letter symbols) pertain to systems, devices, components thereof, and concepts, as involved in embodiments of the present invention.

The proposed method relies on a microfluidic device 10, 10a such as shown in FIG. 1, 2A, 2B, 3, or 6A and 6B. In each case the microfluidic device 10, 10a includes a microreactor 15, 15a, which is defined at an intersection of a first channel 11.1, 11.2 and a second channel 12.1, 12.2 of the microfluidic device 10, 10a. The first channel 11, 1, 11.2 is fenced, at the intersection, by two size-selective filters 14.1, 14.2. i.e., a first filter 14.1 and a second filter 14.2. The first filter 14.1 and the second filter 14.2 are respectively arranged upstream and downstream of the microreactor 15, 15a, in the second channel, so as to delimit the first channel at the level of the intersection, i.e., in the microreactor 15, 15a.

Note, the microreactor 15, 15a divides each channel into two channel portions, i.e., portions 11.1, 11.2 for the first channel and portions 12.1, 12.2 for the second channel. The channel portions may possibly be differently structured and have different shapes. However, the two channel portions of a same channel still define a same flow path and can thus be regarded as forming parts of a same channel, irrespective of the actual designs of such channel portions.

The default flow direction in the second channel extends from the first channel portion 12.1 to the second channel portion 12.2. That is, first, the first filter 14.1 is arranged on an input side (upstream) of the microreactor, while the second filter 14.2 is arranged on an output side (downstream) of the microreactor, where the input side is opposite to the output side with respect to the first channel.

Using this microfluidic device 10, 10a, the method sequentially performs chemical reaction screening steps, denoted by references S30 to S60 in the flow of FIG. 7. Such steps are performed according to distinct combinations of pairs of chemical compounds. Each pair involves a first chemical compound (typically a catalyst) and a second chemical compound. Either the first and/or the second chemical compound is changed across the various screening steps. That is, a combinatorial approach is used to test the chemical compounds. The distinct combinations of pairs of chemical compounds may notably differ in the types of the first and second chemical compounds. In addition, the load of the first chemical compound may be varied too. The catalyst load (i.e., the amount of catalysts in the microreactor) is a function of several variables, involving the bead diameter, a packing density of the beads, and the surface density of the catalyst immobilized on the bead's surface.

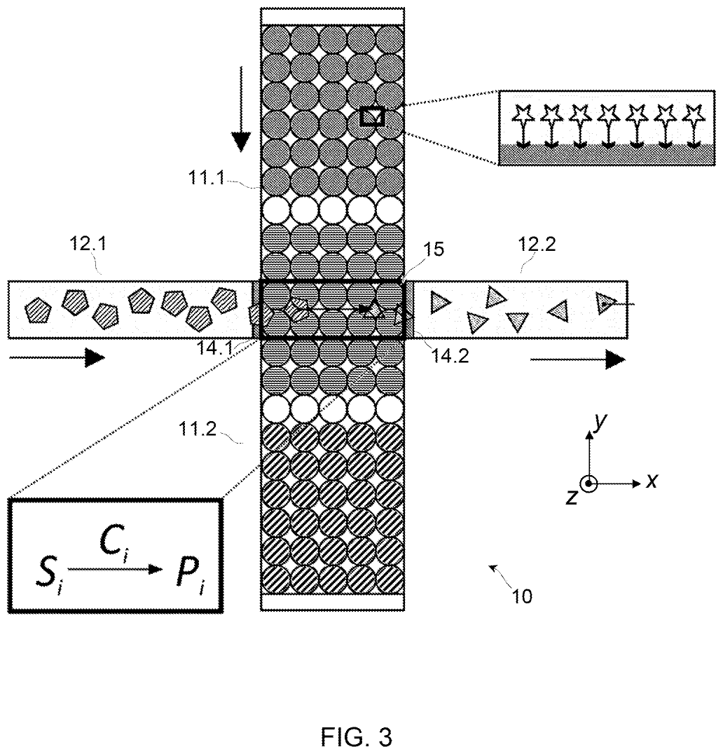

Each chemical reaction screening step first comprises feeding (step S30, FIG. 7) beads into the microreactor 15, 15a through the first channel, either from its first portion 11.1, or the second portion 11.2. The beads are functionalized with the first chemical compound of one of the pairs, as schematically illustrated in the top inset of FIG. 3. In variants, the beads consist (or essentially consist) of the first chemical compound, which is synthesized so as to form a bead, as further discussed below.

Loading the beads in the microreactor 15, 15a causes to laterally confine them between the two size-selective filters. I.e., the size-selective filters are structured to contain and hold the beads, laterally, in the microreactor 15, 15a, so as to prevent the beads from spilling in the second channel.

Next, a solution containing the second chemical compound (of the pair currently explored) is flown S40 along the second channel 12.1, 12.2, upstream of the microreactor 15, 15a. This way, the solution (and thus the second chemical compound) passes through the first filter 14.1, whereby the second chemical compound chemically interacts with the first chemical compound in the microreactor. This yields a reaction product that is eventually flushed through the second filter 14.2. The flows are preferably laminar. Note, there is normally no need to prime the channels before feeding the beads or flowing the solution.

As further seen in FIG. 7, each chemical screening step may further comprise collecting S50 the reaction product in the second channel, in the downstream portion 12.2 thereof, i.e., downstream of the microreactor 15, 15a. The collected reaction product may then be characterized on- or offline. In variants, the reaction product can be directly characterized in the downstream portion 12.2 of the second channel, i.e., downstream of the microreactor 15, 15a. In that case, each chemical screening step further comprises characterizing S60 one or more properties of the reaction product as obtained in the second portion 12.2 of the second channel.

Various characterization methods can be contemplated, including mass spectrometry, high-performance liquid chromatography, and nuclear magnetic resonance, as well as optical methods such as Fourier transform infrared spectroscopy (FTIR), UV-visible spectrometry, Raman spectrometry, etc.

The present approach is particularly suitable for quickly delivering and removing test chemical compound (e.g., catalysts) into the chemical reaction compartment formed by the microreactor 15, 15a. In turns, this makes it possible to let test compounds react efficiently and systematically with probe compounds (the first compounds) flown through the microreactor. In addition, the proposed solution makes it possible to exploit advantages of chemical microreactors, in terms of energy efficiency, scalability, reliability and safety, reaction speed and yield, and reaction control. In particular, using a chemical microreactor allows mixing times, dwell times, and temperature, to be easily controlled.

The proposed method creates a size differentiation between the molecular-scale, test compounds (e.g., catalysts), and the substrates by immobilizing the test compound onto beads or forming aggregates of the first compound, where such aggregates form beads (i.e., sufficiently large objects that cannot pass through the filters). In other words, the microfluidic device uses filtering elements 14.1, 14.2 delimiting the microreactor 15, 15a in the second channel 12.1, 12.2. This makes it possible to easily maintain the test compound in position, inside the microreactor 15, 15a. Thanks to the proposed design, the test compound can be thoroughly removed and quickly replaced by other test compounds, without requiring substantial cleaning or complex operations.

In particular, the proposed approach allows an automated catalyst feed and removal to be achieved, which enables rapid, scalable, multiplexed, and combinatorial screening of reaction pathways, in which substrates, catalysts, and reaction conditions can be alternated with little experimental effort. Remarkably, very small amounts of catalysts suffice, which can further be reused, making the approach fully compatible with typical research-scale quantities. In that respect, in embodiments, the volume of the microreactor 15, 15a, through which a solution I s flown at each step, is less than 5 μl. Such a screening method can advantageously be used in various applications involving chemical synthesis, including drug discovery, production of fertilizers and pharmaceutics, material discovery.

Comments are in order. The channel may possibly be formed as grooves or conduits, or thanks to tubings, which are connected to the microreactor 15, 15a. The average diameter of such channels, conduits, or tubings, is typically of between 100 nm to 100 μm. E.g., each of the average depth and average width of the channels (should they have a rectangular section) may range from 100 nm to 100 μm.

The microfluidic device 10, 10a is preferably designed as a microfluidic chip, fabricated in silicon (Si) or injection molded. In that case, the microfluidic channels (also referred to as channels, or microchannels, herein) can be fabricated as conduits or grooves by etching corresponding structures on the chip, starting with the channels. The microfluidic channels are preferably formed as grooves on a main surface of a (thick) layer of the device. This layer is for example a substrate, or any layer that is sufficiently thick to provide sufficient mechanical stability for the channel. The mechanical stability of the whole device may otherwise be ensured an additional layer underneath. The layer on which the microstructures are patterned will typically form an essentially planar object, such as a chip, a wafer or any such planar support.

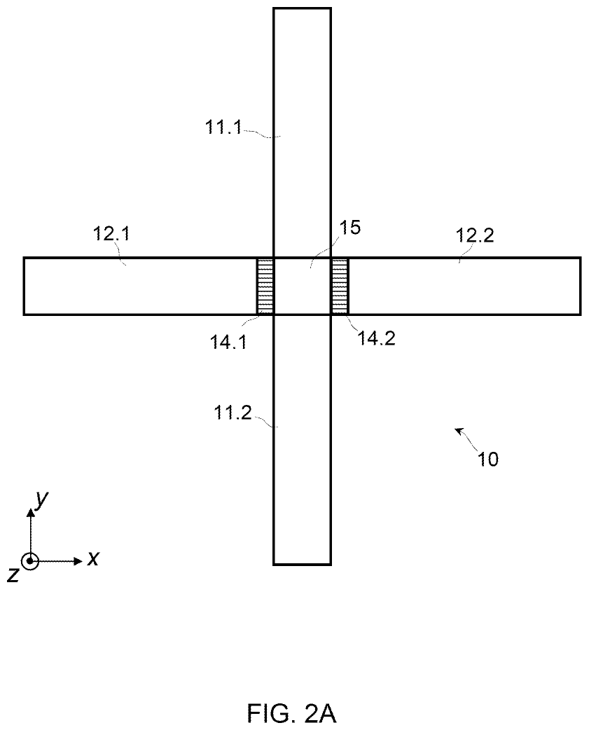

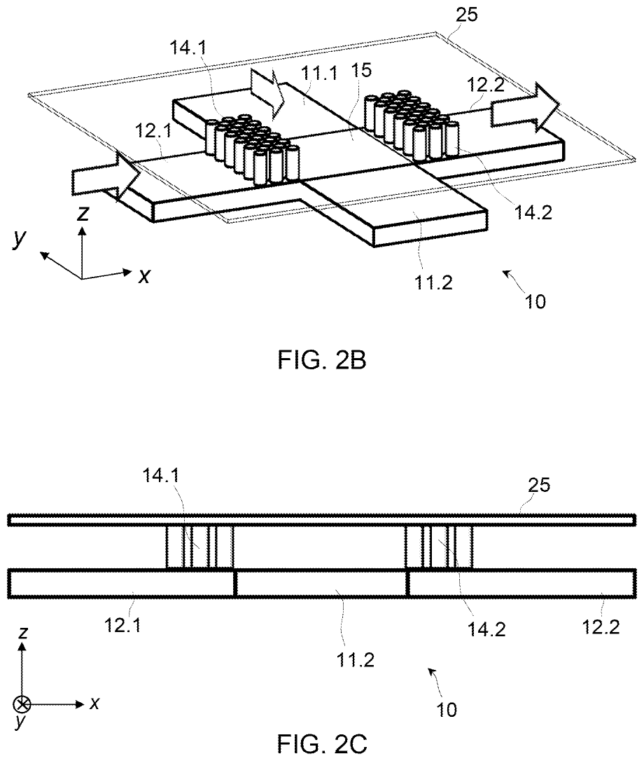

Beyond channels, this layer may include various structures formed thereon or therein, in particular microstructures and other microfluidic features, such as capillary pumps, loading pads, anti-wetting structures, valves, flow resistors, vents, as well as electrodes, electric circuits, and contact pads. The flow path structure may possibly be covered (scaled) by a light-permissive layer 25 (as shown in FIG. 2B), for detection/monitoring purposes. Some particular structures of the device 10, 10a may be in the nanoscale, microscale, or in the millimeter range. However, the devices 10, 10a as a whole is typically in the centimeter range. Note, the lateral walls of the channels are not depicted in FIG. 2B, for the sake of clarity of the depiction. In case light transmission is required, the Si wafer can be etched locally to created view ports, which can be realized using silicon-on-insulator substrates.

In variants, the microfluidic device is fabricated as a thicker device (i.e., bulkier than a chip), in which the channels are typically formed as conduits. Such a device can for instance be made of polydimethylsiloxane (PDMS).

In both cases, each of the two size-selective filters 14.1, 14.2 can be designed and structured so as to prevent the beads from spilling in the second channel 12.1, 12.2. For example, each filter 14.1, 14.2 may comprise structures (such as posts, i.e., columns) extending across the second channel 12.1, 12.2, transversely to a flow direction along the second channel, as illustrated in FIG. 2B. The structures define openings. A minimal dimension of the openings between the structures is such as to prevent the beads from spilling in the second channel 12.1, 12.2. I.e., the filters 14.1, 14.2 are dimensioned in accordance with the beads and, conversely, the beads are selected in accordance with the size-filtering capability of the filters. In practice, the average diameter of the beads is typically between 50 nm and 100 μm. Interestingly, the filters can be created in the same fabrication step as the channels and microreactor structures, whether using Si or PDMS substrates.

The microfluidic device 10 can be complemented by an auxiliary microfluidic device 80, which stores batches of beads in respective reservoirs, formed as parallel channels in the example of FIGS. 6A and 6B. In embodiments, batches of beads are linearly fed through the first channel, one after the other, as illustrated in FIG. 3. Such embodiments are discussed later in detail.

The microreactor 15, 15a is a flow chemistry microreactor, which in embodiments has micrometer dimensions. As noted above, the volume of the microreactor 15, 15a is preferably less than 5 μl. The microfluidic device 10, 10a and the microreactor 15, 15a are preferably made of Si or PDMS. The microreactor should ideally be designed to allow uniform reaction conditions with high space-time yield and high chemical compatibility, it being noted that the conditions can be varied across the screening steps, if necessary.

The beads can for instance be nano- or microspheres made of polystyrene or a resin. Such beads can be functionalized with the first chemical compounds. In general, the functionalized beads may be prepared as composite beads that include a polymer particle coated with an adsorption material, itself immobilizing a chemical compound such as an enzyme, as illustrated in the top inset of FIG. 3. Suitable examples of enzymes include cellulase, endoglucanase, cellobiohydrolase, hemicellulase, mannanase, xylanase, pectinase, pectin esterase, pectin and pectate lyase, gamanase, esterase, laccase, and lipase.

In embodiments, the beads can be formed as macromolecular objects, where catalysts are hosted inside such objects. In that case too, the beads can be regarded as being functionalized with catalysts. In other variants, the beads are enzymatic beads, i.e., aggregates formed by enzymes. In that case, the beads consist (or essentially consist) of enzymes. More generally, the beads may be formed thanks to chemical compounds including polymers, and/or cells. Note, the concept of “chemical compound” should be understood broadly in this document, inasmuch as the first chemical compound may include a single chemical element, such as a single-element catalyst. Now, as known per se, single-element catalysts can be assembled into pellets to form beads. In the majority of embodiments assumed herein, though, the first chemical compound is a substance formed from two or more chemical elements, where this substance acts as a catalyst.

All this is now described in detail, in reference to particular embodiments of the invention. To start with, referring to FIGS. 3-5 and 7, the first chemical compounds preferably include catalysts. That is, the first chemical compound of at least some of the distinct combinations of pairs of chemical compounds includes a catalyst. In that case, flowing S40 the solution along the second channel 12.1, 12.2 gives rise to a chemical reaction involving the second chemical compound as a reactant, and this chemical reaction is catalyzed by the catalyst as the second chemical compound interacts S40 with the catalyst in the microreactor 15, 15a. Note, the reaction may solely involve a single reactant, i.e., the second chemical compound. In variants, the reaction may involve one or more additional reactants, provided in the solution (or a mixture of solutions) flown in the second channel 12.1, 12.2.

The phase of the catalysts differs from that of the solution flown, because the catalysts are aggregated as or immobilized on the beads (solid objects), even if the beads are dispersed in a liquid medium (e.g., a solvent). That is, an appropriate anchoring strategy can be chosen so that the catalysts still behave like free molecules. In particular, anchoring strategies may be devised to preserve the catalytic reactivity of the chemical moiety, while still providing a sufficient mechanical coupling. Examples of suitable anchoring strategies involve alkane chains, as known per se. In such cases, the reaction can be regarded as a heterogeneous catalysis. The beads are usually solid particles. In some case, they can safely be stored in a solvent. In variants, they are stored in a dry environment (e.g., in a gas medium). The best approach depends on the type of catalysts immobilized. In general, the medium used for the catalysis reaction in the microreactor will be selected so as not to affect the chemical integrity of the immobilized molecules and the beads themselves. It should further be preferably selected so as not to prevent or substantially affect the desired chemical reaction. It is, in principle, possible to use a “dry” system and perform heterogeneous catalysis in a gas medium, something that can be advantageous for applications like CO₂ conversion, for example.

In embodiments, at least some of the chemical reaction screening steps are repeatedly performed under different experimental conditions applied S45 to the microreactor 15, 15a, see FIG. 7. In particular, one may vary the temperature, thanks to a heater placed in, on, or close to the microreactor. In variants, or in addition, one may vary the experimental conditions may applied to the first chemical compounds in the first channel, i.e., prior to entering the microreactor. Similarly, different experimental conditions may be applied to the second chemical compounds in the second channel, prior to flowing the second compound through the microreactor. Various types of modifications of the experimental conditions can thus be contemplated, whether concerning temperature, pressure, the solvents used, the pH, illumination, electric fields, particle concentrations, additives, etc. For example, the same pairs of substrate-catalyst can be tested against different sets of temperatures, pH, illumination, electric fields and concentrations (of substrates and/or catalysts). So, it is possible to systematically vary and test reaction conditions for a variety of combinations of substrates and catalysts.

Once loaded in the microreactor 15, 15a, the beads are confined between the two size-selective filters 14.1, 14.2, meaning that they cannot escape into the second channel.

A batch of beads loaded in the microreactor can otherwise be surrounded, and thus confined, by upstream and downstream batches of beads, should the batches be linearly loaded in a densely packed manner in the first channel 11.1, 11.2 and then successively loaded through the microreactor 15 (a concept referred to as “linear registry” herein), as assumed in FIG. 3. I.e., the distinct batches form a linear registry of first compounds. In that case, feeding a new batch of beads into the microreactor flushes the former batch (if any) from the microreactor.

In embodiments relying on a linear registry, the distinct batches can be prepared during a preprocessing step and queued in one portion of the first channel 11.1, 11.2, with a view to successively loading the batches to perform the screening steps. That is, one may pile up S20 batches of distinctly functionalized beads in the channel 11.1, 11.2 and then successively feed S30 the batches into and through the microreactor 15. The obtained batches form successive heaps along the first channel 11.1, 11.2, as depicted in FIG. 3.

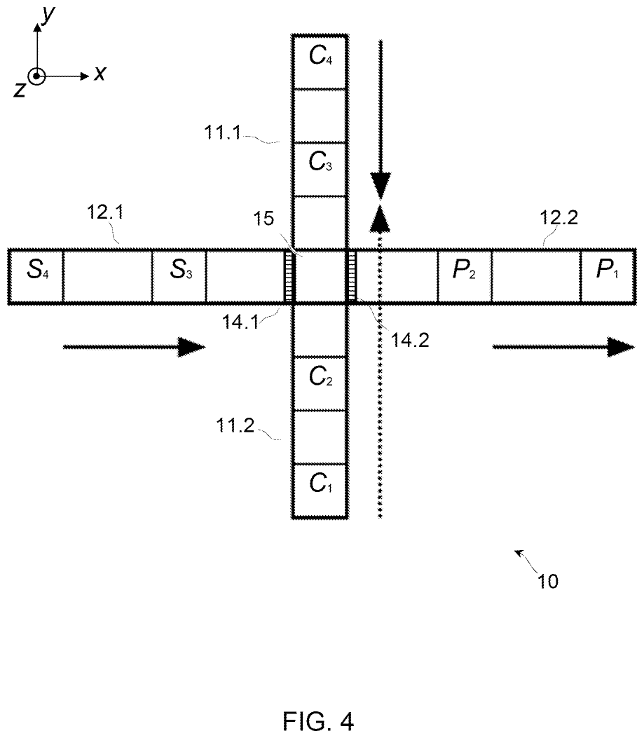

In embodiments, the batches can be reused multiple times, in particular when the beads are functionalized with, or somehow include or consist of, catalysts, which are not altered by the reactions. That is, the chemical reaction screening steps can be sequentially performed by repeatedly using at least one of the batches of beads. Being able to reuse the same batches is advantageous when systematically testing various experimental conditions or, more generally, where the same first compounds are needed multiple times. The beads can be reused either by re-feeding the same beads into the microreactor in a closed circuit (not shown) or by reversing the feed direction. Preferred is to reverse the feed direction, as suggested by the upward, dotted arrow in FIG. 4. Reversing the feed direction means reversing the direction according to which the batches are fed into the microreactor 15 through the first channel 11.1, 11.2. In both cases, a protocol can be used, which optimizes the sequences of solutions and batches of beads used throughout the screening steps, e.g., by minimizing the changes of solution flown through the second channel.

Indeed, the input substrates can be changed too, e.g., by switching the input solutions flown in the second channel 12.1, 12.2. Thus, in embodiments, the type of solution flown along the second channel 12.1, 12.2 is changed at one or more of the screening steps, as illustrated in FIG. 4. In this example, a first and second solutions S₁ and S₂ (not shown), respectively containing first and second substrates, are assumed to have been successively flown in the first portion 12.1 of the second channel, to respectively react thanks to catalysts C₁ and C₂ in the microreactor 15, and yield reaction products P₁ and P₂ that are flushed in the second portion 12.2 of the second channel. Additional solutions S₃ and S₄ (respectively containing third and fourth substrates) are then flown in the first portion 12.1 of the second channel, with a view to reacting them thanks to respective catalysts C₃ and C₄. In other words, the various substrates and catalysts involved give rise to catalytic reactions

$${S}_{i} {\to }^{{C}_{i}} {P}_{i} ,$$

where Pᵢ denotes the i^{th} reaction product. Note, this notation uses the same symbol Sᵢ for the input solutions and the input substrates; Sᵢ denotes the i^{th} solution flown, which contains an i^{th} substrate.

The feed direction of the catalysts can then be reversed (see the dotted arrow) to test further combinations of catalysts and substrates, whereby different solutions may again be flown in the second channel. In other words, batches of beads are initially fed on one side of the microreactor 15. Then, at a subsequent step, the feed direction is reversed, such that the beads are fed into the microreactor 15 from the opposite side thereof. That is, the catalyst registry can be moved back and forth along the first channel 11.1, 11.2, to alternate the reactions taking place in the microreactor 15. Still, the solutions flown may differ, leading each time to different chemical reactions, the reaction products of which are analyzed by subsequent online or offline analytics.

Note, changing the input solution does not necessarily mean changing the type of substrates used as input. E.g., the input solutions may involve different substrate concentrations and/or different solvents, the aim being to screen different reaction pathways and reaction conditions. Changing the solvent may affect the chemical reactivity. Similarly, some of the batches of beads may possibly involve different concentrations (e.g., catalyst loads) of the same first compounds.

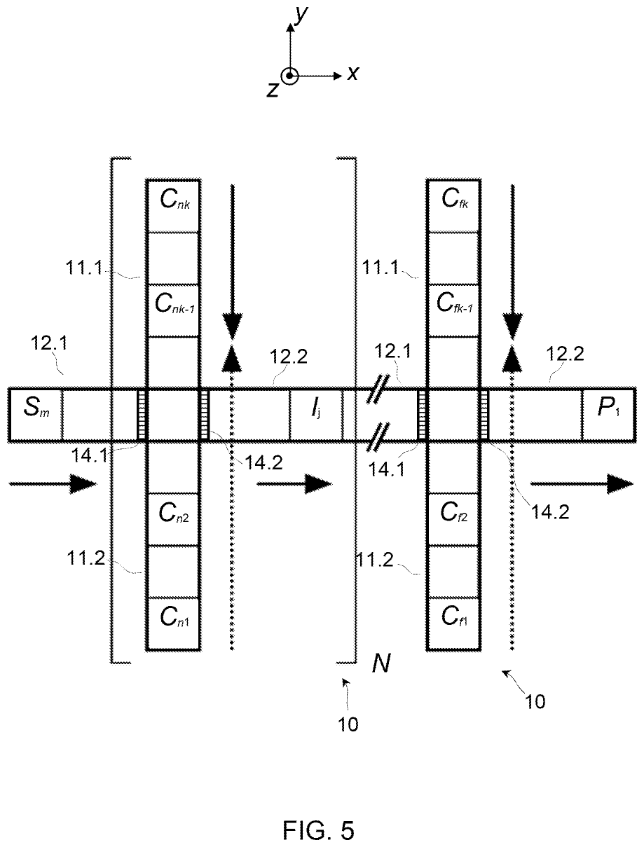

The scenario depicted in FIG. 5 involves N+1 microfluidic devices (N≥1), which are cascaded. That is, the N+1 microfluidic devices are arranged in series, so that the solution Sₘ (m=1, . . . , M) flown through the microreactor of one microfluidic device 10 yields an intermediate reaction product Iⱼ (j=1, . . . . J, where J≤N×M) which enters the first portion of the second channel of the next device 10, and so on. Eventually, a final reaction product Pₘ (m=1, . . . , M) is obtained. This makes it possible to test of variety of serialized catalysts. The catalysts of the first N microfluidic devices form a matrix having elements Cₙₖ, where n ranges from 1 to N and k ranges from 1 to K. The final microfluidic device 10 is used to successively load catalysts Cₙₖ, where “f′ stands for “final.

One may advantageously create well-defined registries of catalysts by preparing alternating sequences of batches of functionalized beads (i.e., whether including or consisting of the first compounds) and passive spacer beads. That is, when piling up S20 the batches, batches of spacer beads may be intercalated between successive batches of functionalized beads in the first channel 11.1, 11.2. In that case, each batch of spacer beads separates two successive heaps of distinctly functionalized beads. I.e., two distinct batches of functionalized beads are separated by one batch of spacer beads and arranged on each side of this batch of spacer beads.

The spacer beads are used to spatially separate the functional beads used for the chemical screening steps and avoid inadvertent catalysis. This is illustrated in FIG. 3, showing three distinct batches of functionalized beads (shown as disks respectively filled by wide upward diagonal stripes, horizontal stripes, and then light upward diagonal stripes) separated by batches of non-functionalized beads (white disks). The substrates and the reactions products are respectively denoted by pentagons and triangles in this example. The inset on top schematically illustrates catalysts immobilized on a bead surface, while the bottom inset illustrates a generic catalytic reaction

$${S}_{i} {\to }^{{C}_{i}} {P}_{i} .$$

Interestingly, at least some of the beads may have a detectable electromagnetic property, which can be exploited to help position the beads in the microreactor. In principle, any of the catalyst beads and/or the spacer beads can have such a property. This property may for instance be an optical property (such as phosphorescence or fluorescence). For example, use can be made of beads that are functionalized with a fluorescent or phosphorescent dye. That is, a dye can be attached to the catalysts at a non-catalytically active moiety. This optical property can then be detected thanks to an optical detector. For example, computer vision can be exploited to detect certain beads in the vicinity of the microreactor. Another possibility is to use a camera coupled to a microscope and perform image processing, e.g., to detect changes of contrast in the first channel.

In embodiments, the exploited property is a magnetic property, which can be calibrated so as not to affect the chemical activity. This magnetic property may be directly detected by a magnetic field sensor. For example, magnetic beads can be used as spacers, which gives rise to a detectable magnetic field present all along the channel.

The detectable property of the beads can advantageously be exploited to accurately position the beads in the microreactor 15. That is, the beads may be fed into the microreactor 15 by moving the beads along the first channel 11.1, 11.2, while detecting S35 the electromagnetic property of beads, e.g., in the vicinity of the microreactor 15. The detector 71, 72 (i.e., a camera, an optical detector, or a magnetic field sensor) may be positioned and otherwise configured to detect beads in a vicinity of the microreactor 15, while moving the beads. In turn, this information is used to infer the position of the registry and adjust S30 the position of the batch of beads in the microreactor. A simple feedback loop between this detector 71, 72 and the bead supply can be used to that aim.

Note, the piled-up batches shall preferably make up segments of approximately the same length (in the first channel), something that helps to position the batches in the microreactor 15. For example, the distinct batches of beads can be piled up S20 so as to have constant segment lengths in the first channel 11.1, 11.2, subject to a relative standard deviation of this length that is less than 10% or even 5%. The more constant the segment lengths, the easier and more accurate the positioning of beads inside the microreactor.

The above embodiments concern a linear registry, where batches of beads are queued, one after the other, in the same input channel 11.1. In embodiments, batches of beads can be preloaded in respective channels 81-83 of an auxiliary device 80 (only three such channels are depicted in FIGS. 6A and 6B, for simplicity), as now discussed in detail in reference to FIGS. 6A and 6B. In this case, the device 80 is paired to the microfluidic device 10a and batches of beads are successively loaded into the microreactor 15 from the neighboring device 80. Once used, the beads can be disposed or, preferably, reloaded in the loading channels 81-83, with a view to further using the beads, if necessary. The auxiliary device 80 is sometimes referred to as a reservoir device. This device 80 is preferably a microfluidic device of its own, which may include any number of loading channels 81-83, a concept referred to as “parallel registry” in this document. Note, the loading channel do not necessarily need to be arranged in parallel in the device 80. In addition, the loading channels may have any suitable shape; they may for instance include enlarged portions forming reservoirs, contrary to what is shown in FIGS. 6A and 6B.

In principle, the beads may be loaded in a microreactor fenced by only two opposite, size-selective filters, as assumed in FIGS. 1-5. The beads may for instance be loaded through a first channel portion 11.1 and then be flushed through the other channel portion 11.2. Such an arrangement, however, does not easily permit to reuse the beads, unless closed-loop circuits are provided, which connect the channel portion 11.2 back to the loading channels 81-83, something that is not easily achieved, in practice.

Therefore, another possibility is to fence the microreactor with a third filter 14.3. That is, the beads can be blocked by a third fence 14.3, downstream of the microreactor 15a in the first channel 11.2. More precisely, the first channel 11.1, 11.2 is further fenced, at the intersection, by a third size-selective filter 14.3, which is arranged in (and across) the first channel on one side of the microreactor 15, so as to prevent loaded beads from exiting the microreactor 15 through the second portion 11.2 of the first channel, i.e., on said one side. In operation, the beads are loaded, at each chemical screening step, from the other side of the microreactor 15a, opposite to said one side. The beads are removed at the end of each chemical screening step (i.e., after flowing the solution). The beads can be removed by flowing a rinsing solution along the first channel 11.1, 11.2, from the other side of the microreactor, or by aspirating the liquid that is already present in the first channel, from the first portion 11.1 of the first channel. In both cases, a liquid flows through the third size-selective filter 14.3 (from the second channel portion 11.2 to the first portion 11.1) and flushes the beads in the first channel on said one side, where the beads can be appropriately recycled (e.g., stored). In other words, the microreactor 15a is a dead end for the beads in that case, and the beads must be expelled in the same direction from which they were loaded in the first place, before loading a new batch of beads.

The beads can for instance be dispersed in a solvent and then filled in the channel using. e.g., a syringe 21a, as assumed in FIGS. 6A and 6B. The syringe preferably has a stirrer (not shown) to preserve a homogeneous emulsion and prevent undesired aggregations. In more sophisticated variants, pumping means and flow control can here again be used. However, the solution depicted in FIGS. 6A and 6B is simpler and more affordable; the downside being that it requires a manual control.

FIG. 7 shows a preferred flow of operations, applicable to embodiments shown in FIGS. 1-6B. During a preliminary step S10, the beads are functionalized with catalysts. Distinct batches of beads are then prepared S20. The bathes are either piled up linearly in an input channel 11.1, if necessary separated by spacer beads (as in FIG. 3) or placed in loading channels 81-83 of an auxiliary chip 80 (as in FIGS. 6A and 6B). At step S30, a next batch of beads is controllably loaded in the microreactor 15, 15a through the first portion 11.1 of the first channel. This step may benefit from a sensory feedback to accurately control the position of the batch in the microreactor 15 (as in FIG. 1). To that aim, a signal is detected S35, which originates from the beads (e.g., spacer beads) and the batch position is refined in accordance with the detected signal. At step S40, a solution is transversely flown through the microreactor 15, 15a. The solution is injected through the first portion 12.1 of the second channel, which causes a catalysis to occur in the microreactor 15, 15a. If necessary, experimental conditions in the microreactor (e.g., temperature) can be tuned S45, before or after flowing S40 a solution (i.e., before or after each step). The reaction product is collected at step S50, downstream of the microreactor. One or more properties of the collected reaction product are then characterized at step S60, either offline or online. Steps S30-S60 are repeatedly performed, so as to iteratively perform chemical reaction screening steps. Note, where the characterization is performed offline, step S60 is performed outside of the loop. The collected reaction products may possibly be analyzed in batch, instead of one after the other.

Another aspect of the invention concerns a system 1, 1a for performing chemical reaction screening steps. Such a system 1, 1a is depicted in FIGS. 1 and 6A, 6B. The system 1, 1a basically comprises a microfluidic device 10, 10a, a bead supply 21, 21a, 22, 80 and a solution supply 30.

Some features of the microfluidic device 10, 10a have already been described in reference to the previous aspect of the invention. Such features are only briefly described in the following. The device 10, 10a includes a first channel 11.1, 11.2, a second channel 12.1, 12.2, and a microreactor 15, which is defined at an intersection of the first channel and the second channel. The first channel 11.1, 11.2 is fenced, at the intersection, by at least two size-selective filters 14.1, 14.2, i.e., a first filter 14.1 and a second filter 14.2. The first filter 14.1 and the second filter 14.2 are respectively arranged upstream and downstream of the microreactor 15 in the second channel.

The bead supply 21, 21a, 22 can be connected to the first channel 11.1, 11.2. The bead supply 21, 21a, 22 stores distinct batches of beads that are functionalized with, or consist of, first chemical compounds. The distinct batches correspond to distinct chemical compounds (the first chemical compounds), or compounds having different properties, such as a different load. The beads are dimensioned so as to remain laterally confined between the two size-selective filters once loaded into the microreactor 15.

The solution supply 30 can be connected to the second channel 12.1, 12.2. The solution supply 30 stores one or more solutions, which respectively contain one or more second chemical compounds. The liquid supply may include one or more syringes 23, as assumed in FIGS. 6A and 6B. Similarly, the bead supply may include one or more syringes 21a, which can be loaded with respective solutions containing beads.

As explained in reference to the first aspect of the invention, the system 1, 1a is well suited to sequentially perform S30-S60 chemical reaction screening steps according to distinct combinations of pairs of chemical compounds.

In general, the present microfluidic devices 10, 10a, 80 can be fabricated using standard lithographic methods. For example, a suitable method of fabricating a microreactor 15, 15a with size-selective filters 14.1, 14.2, 14.3, comprises patterning a lithographic resist on top of a substrate, for the resist to define, on the one hand, the microchannels 11.1, 11.2, 12.1, 12.2, and, on the other hand, the filtering elements 14.1-14.3. The latter may notably form structures extending, each, transversely to the substrate, as depicted in FIGS. 2A-2C. In this example, the structures are formed as posts that extend perpendicularly to the main substrate, on which the flow paths are defined. I.e., each size-selective filters 14.1, 14.2 comprises structures extending across the second channel 12.1, 12.2, transversely to a flow direction along the second channel. Note, the filter structures will preferably extend from a bottom wall of the second channel (defining the flow path) to a top wall 25 (or lid). This prevents beads from passing above or below the filter structures and further provides additional mechanical stability to the device 10, 10a, as assumed in FIG. 2B. Where the microfluidic devices are made of PDMS, the structures can be fabricated as negatives of the desired channels and transferred into PDMS by molding. Where the microfluidic devices are made of Si, the structures can for instance be etched in the Si substrate and closed by anodic bonding of a glass cover.

The structures define openings. Ideally, a minimal dimension of the openings between the structures is less than the minimal diameter of the beads meant to be fed in the microreactor 15, 15a. That is, the minimal dimension of such openings is substantially smaller than the average diameter of the beads of any of the batches, e.g., twice smaller. In practice, the beads can be chosen or formed so that their diameters have a relatively small dispersion. As a result, the beads do essentially not pass through the filters. The lithographic resist is used as a mask to protect residual portions of the substrate upon etching, to thereby obtain the reaction compartment, the selective filters, and the corresponding channel sections.

The size-selective filters 14.1, 14.2 extend along the first channel, on opposite sides thereof, in the microreactor. I.e., the filters 14.1, 14.2 border the first channel in the microreactor. However, the microreactor is still open on one or two sides in the first channel, such that the batches of beads can be successively fed S30 on any open side of the microreactor 15, 15a. In embodiments, the first channel 11.1, 11.2 is fenced, at the intersection, only by two size-selective filters 14.1, 14.2. In that case, the beads can be fed on one side of the microreactor 15 and expelled from the opposite side, by shifting the batches of beads along the same direction as used to feed them, along the first channel. I.e., no third filter is desired in that case because the beads are meant to transit through the microreactor 15.

Conversely, other embodiments of the system 1a involves a third filter 14.3, as illustrated in FIGS. 6A and 6B. That is, the first channel 11.1, 11.2 is further fenced, at the intersection, by a third size-selective filter 14.3, which is arranged on one side of the microreactor 15 in the first channel 11.1, 11.2. The first channel is fenced by exactly three size-selective filters 14.1, 14.2, 14.3 in this example.

In the example of FIGS. 6A and 6B, the bead supply 21a, 80 comprises an auxiliary microfluidic device 80, which is connected to the main device 10a. The auxiliary device 80 includes a plurality of loading channels 81-83, which are selectively connectable to the first channel 11.1, 11.2 of the device 10a. Each of the loading channels is fenced by a respective size-selective filter 81f-83f. The loading channels 81-83 can therefore hold respective batches of beads, which may potentially be loaded into the main device 10a.

The system 1a may further comprise ports and selector valves. In the example of FIGS. 6A and 6B, the system 1a includes a first selector valve 91a, which itself includes a number of first ports 91p. The first ports 91p include loading ports, i.e., ports that are connected to respective ones of the loading channels 81-83. In addition, one of the ports 91p is an input port 91i (call it a first input port), which can be connected to an external element such as a syringe 21a, e.g., a bead supply. The first selector valve 91 is otherwise configured to controllably connect the first portion 11.1 of the first channel to one of the first ports 91p, such that the first channel 11.1, 11.2 can be selectively set in fluidic communication with any one of the loading channels 81-83 and the input port 91i. This, in turn, makes it possible not only to selectively load the batches of beads as stored in the loading channels 81-83 but, in addition, to preload the channels 81-83 with beads, via the input port 91i.

As best seen in FIG. 6B, the system 1a may further comprise a second selector valve 92, which includes a plurality of second ports 91i, 92p. The second ports include unloading ports 92p, i.e., ports that are connected to respective ones of the loading channels 81-83. In addition, one of the second ports is an input port 92i (call it a second input port), which can be connected to an external element such as a syringe 23, i.e., a liquid supply. The second selector valve 92 is otherwise configured to controllably connect the second input port 92i to either one of the unloading ports, so as to allow any connected channels 81-83, 11.1, 11.2 to be filled with liquid injected from the input port 92i.

In detail, FIGS. 6A and 6B show a chemical reaction pathway screening system 1a that comprises a microfluidic chip 10a, a reservoir chip 80, selector valves 91, 92, and syringes 21a. 23. The microfluidic chip 10a includes a triply fenced, orthogonal flow reactor 15a, which is arranged at the intersection of the first channel 11.1, 11.2 and the second channel 12.1, 12.2. The reservoir chip 80 has multiple loading channels 81-83, which define compartments. The loading channels 81-83 are fenced 81f-83f on one side to hold respective batches of beads, e.g., carrying different catalysts, once preloaded therein. A liquid supply 30 can be connected to the first portion 12.1 of the second channel. The syringe 23 can be connected to the first portion 11.1 of the first channel 11.1, 11.2, this depending on the setting of the selector valves 91, 92. The selector valves 91, 92 can only enable one input and one output at a time, as per their internal mechanism. Still, they can be used to iteratively address (i.e., switch) the exchange paths one after another, whereby all channels can potentially be filled with liquid, e.g., a solvent. A liquid container can typically be connected to the second portion 12.2 of the second channel to collect excess liquid. Similarly, a liquid containers can be connected to the second portion 11.2 of the first channel, if necessary.

The syringe 21a is used to load (or extract) different types of beads into the reservoir chip 80. The syringe 23 can be used to move a solvent in forward and backward direction. I.e., it can be used to inject the solvent for it to fill the connected channels, by pushing the plunger of this syringe 23. In addition, the plunger can be pulled to bring the beads back from the microreactor 15a to the relevant loading channel 81-83. Note, instead of a second selector valve, a series of syringes may be used for each loading channel.

In more sophisticated embodiments, such as illustrated in FIG. 1, the system 1 includes a control system 40. The control system 40 is operatively connected to the bead supply 21, 22 and the solution supply 30 to sequentially perform chemical reaction screening steps according to distinct combinations of pairs of chemical compounds, as explained earlier. In operation, each chemical reaction screening step first comprises actuating the bead supply 21, 22 to feed a next batch of beads into the microreactor 15 through the first channel 11.1, 11.2, where the beads are functionalized with a first chemical compound. Each chemical reaction screening step further comprises actuating the solution supply 30 to flow a solution along the second channel 12.1, 12.2, upstream of the microreactor 15. The solution contains a second chemical compound; the first and second chemical compounds form a pair of chemical compounds, and several pairs of such compounds can be tested across various chemical reaction screening steps. In operation, the second chemical compound included in the solution flown passes through the first filter 14.1 and interact with the first chemical compound in the microreactor 15, which yields a reaction product in the solution flown that is flushed in the second channel through the second filter 14.2.

In that case too, the liquid flows can be controlled via syringes. In variants, use is made of control valves and pressure control means, e.g., based on active e.g., pressure-driven pumping, electroosmotic pumps, peristaltic pumps, and/or vacuum pumps. MEMS-based valves or plunger valves can be embodied directly on the microfluidic device 10. Such microfluidic device components are known per se. Note, two bead supplies 21, 22 may be provided, on either end of the first channel 21, 22. Such supply may possibly be alternately actuated, to reverse the feed direction, if necessary (as discussed earlier in reference to another aspect of the invention). In embodiments, the valve 91 forms part of the microfluidic devices 10a. The microreactor chip 10a and the reservoir chip 80 may also be fabricated as a single on-a-chip system.

In the example of FIG. 1, the system 1 further comprises a collector 50, which is arranged to downstream of the microreactor 15. The collector 50 can be used for post-synthesis treatments, e.g. a solvent exchange, characterization purposes or sample deposition. It can be fabricated as a delay line, a compartment, or a view port. It can also be equipped with microfluidic components to analyze the products or to enable sample extraction. The control system 40 is operatively connected to the collector 50 to actuate the collector, for it to collect a sample of reaction product as flushed through the second portion 12.2 of the second channel, downstream of the microreactor 15, in operation. The collected sample can then be stored and sent for offline analysis, as in embodiments.

In embodiments, though, the system 1 further comprises a characterization apparatus 60. In that case, the control system 40 is operatively connected to the characterization apparatus to control the latter, so as for the characterization apparatus 60 to characterize one or more properties of reaction products as obtained in the second channel 12.1, 12.2, downstream of the microreactor 15, in operation of the system 1. In the example of FIG. 1, the system 1 comprises both a collector 50 and a characterization apparatus 60, whereby the apparatus 60 performs characterization based on samples collected by the collector 50, in operation. Various types of characterizations can be contemplated, including, e.g., mass spectrometry, high-performance liquid chromatography, nuclear magnetic resonance, optical characterization such as FTIR, UV-visible spectrometry, Raman spectrometry, etc.

In embodiments, the system 1 further comprises one or more detectors 71, 72, which are arranged so as to detect an electromagnetic property of at least some of the beads in the first channel 11.1, 11.2, in operation. The properties can for instance be an inherent property (e.g., fluorescence, phosphorescence) of spacer beads, or an electric property generated upon moving magnetic spacer beads, as discussed earlier. The control system 40 is operatively connected to the detector for it to detect said electromagnetic property (e.g., upon moving the beads through the microreactor 15) and generate a corresponding control signal. This control signal can then be used to accurately position a given batch of beads in the microreactor 15, prior to transversely flowing a solution by actuating the liquid supply 30.

While the present invention has been described with reference to a limited number of embodiments, variants, and the accompanying drawings, it will be understood by those skilled in the art that various changes may be made, and equivalents may be substituted without departing from the scope of the present invention. In particular, a feature (device-like or method-like) recited in a given embodiment, variant or shown in a drawing may be combined with or replace another feature in another embodiment, variant or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention is not limited to the particular embodiments disclosed, but that the present invention will include all embodiments falling within the scope of the appended claims. In addition, many other variants than explicitly touched above can be contemplated. For example, other materials than PDMS and silicon can be used to fabricate the chips 10, 10a, 80. Such chips may for instance contain lids made of a distinct material.

What is claimed is:

1. A method of performing chemical reaction screening steps, wherein the method comprises:
providing a microfluidic device having a microreactor defined at an intersection of a first channel and a second channel, wherein the first channel is fenced, at the intersection, by two size-selective filters, these including a first filter and a second filter, respectively arranged upstream and downstream of the microreactor in the second channel; and
sequentially performing chemical reaction screening steps according to distinct combinations of pairs of chemical compounds, each of the pairs involving a first chemical compound and a second chemical compound, wherein each step of the chemical reaction screening steps comprises:
feeding beads into the microreactor through the first channel to confine the beads between the two size-selective filters, wherein the beads are functionalized with, or consist of, the first chemical compound of one of the pairs; and
flowing a solution containing the second chemical compound of said one of the pairs along the second channel, upstream of the microreactor, for the second chemical compound to pass through the first filter and chemically interact with the first chemical compound in the microreactor, to yield a reaction product that is flushed through the second filter.

2. The method according to claim 1, wherein
for each of at least some of the distinct combinations of pairs of chemical compounds, the first chemical compound includes a catalyst, and flowing the solution along the second channel gives rise to a chemical reaction involving the second chemical compound as a reactant, wherein the chemical reaction is catalyzed by the catalyst upon the second chemical compound interacting with the catalyst in the microreactor.

3. The method according to claim 1, wherein
at least some of the chemical reaction screening steps are repeatedly performed under different experimental conditions applied to the microreactor.

4. The method according to claim 1, wherein the distinct combinations of pairs of chemical compounds differ in one or more of:
a type of the first chemical compound,
a type of the second chemical compound, and
a load of the first chemical compound.

5. The method according to claim 1, wherein
the first channel is further fenced, at the intersection, by a third size-selective filter, which is arranged in the first channel on one side of the microreactor, so as to prevent the loaded beads from exiting the microreactor through the first channel on said one side;
the beads are loaded, at said each step, from another side of the microreactor, opposite to said one side; and
said each step further comprises, after flowing the solution to obtain the reaction product, removing the confined beads by flowing a given solution along the first channel, for the given solution to flow through the third size-selective filter and flush the beads in the first channel on said one side.

6. The method according to claim 1, wherein the method further comprises, prior to performing the chemical reaction screening steps:
piling up distinct batches of beads in the first channel, with a view to successively feeding the batches into the microreactor to perform said chemical reaction screening steps.

7. The method according to claim 6, wherein
the chemical reaction screening steps are sequentially performed by repeatedly using at least one of the batches of beads.

8. The method according to claim 7, wherein sequentially performing the chemical reaction screening steps comprises:
changing a type of solution to be flown along the second channel; and
reversing a direction according to which the batches are fed into the microreactor through the first channel.

9. The method according to claim 6, wherein piling up the distinct batches of beads comprises:
intercalating batches of spacer beads between the distinct batches in the first channel, whereby one batch of spacer beads demarcates two successive ones of the distinct heaps of the of distinctly functionalized beads on each side of said one batch.

10. The method according to claim 9, wherein feeding the beads into the microreactor further comprises:
moving the beads, wherein at least some of the beads have a detectable electromagnetic property;
while moving the beads, detecting the electromagnetic property of said at least some of the beads that are in a vicinity of the microreactor; and
adjusting a position of one of the distinct batches of beads in the microreactor, based on the detected electromagnetic property.

11. The method according to claim 9, wherein
the distinct batches of beads are piled up so as to have constant segment lengths in the first channel, subject to a relative standard deviation of less than 5%.

12. The method according to claim 1, wherein said each step further comprises:
collecting the reaction product in the first channel, downstream of the microreactor.

13. The method according to claim 1, wherein said each step further comprises:
characterizing one or more properties of the reaction product.

14. The method according to claim 1, wherein
an average diameter of the beads is between 50 nm and 100 μm.

15. The method according to claim 1, wherein
the volume of the microreactor through which the solution is flown at said each step is less than 5 μl.

16. A system for performing chemical reaction screening steps, wherein the system comprises:
a microfluidic device including a first channel, a second channel, and a microreactor defined at an intersection of the first channel and the second channel, wherein the first channel is fenced, at the intersection, by two size-selective filters, these including a first filter and a second filter, which are respectively arranged upstream and downstream of the microreactor in the second channel;
a bead supply, which is connectable to the first channel, wherein the bead supply stores distinct batches of beads that are functionalized with, or consist of, first chemical compounds, the distinct batches corresponding to distinct ones of the first chemical compounds, the beads are dimensioned to be confined between the two size-selective filters if loaded into the microreactor; and
a solution supply, which is connectable to the second channel, the solution supply storing one or more solutions respectively containing one or more second chemical compounds.

17. The system according to claim 16, wherein
each of the two size-selective filters comprises structures extending across the second channel, transversely to a flow direction along the second channel, the structures defining openings; and
a minimal dimension of said openings is less than an average diameter of the beads of any of the batches.

18. The system according to claim 16, wherein
the two size-selective filters and the microreactor are configured so that the batches of beads can be successively fed into the microreactor and removed from the microreactor by translating the batches of beads along a same direction along the first channel, in operation.

19. The system according to claim 16, wherein
the first channel is further fenced, at the intersection, by a third size-selective filter, which is arranged on one side of the microreactor in the first channel.

20. The system according to claim 19, wherein
the bead supply comprises an auxiliary microfluidic device, which includes a plurality of loading channels that are selectively connectable to the first channel; and
each channel of the loading channels is fenced by a respective size-selective filter to hold a respective batch of beads in said each channel.

21. The system according to claim 20, wherein
the system further comprises a first selector valve, which itself includes selectable ports, the selectable ports including an input port and a plurality of loading ports, the latter connected to respective ones of the loading channels; and
the first selector valve is configured to controllably connect the first channel to either one of the selectable ports.

22. The system according to claim 21, wherein
the system further comprises a second selector valve, itself including a plurality of second ports;
the second ports include a second input port as well as unloading ports, which are connected to respective ones of the loading channels; and
the second selector valve is configured to controllably connect the second input port to either one of the loading channels.

23. The system according to claim 16, wherein
the system further comprises a control system and a collector, the latter arranged downstream of the microreactor; and
the control system is operatively connected to the collector to actuate the latter, for the collector to collect a reaction product in the second channel, downstream of the microreactor, in operation of the system.

24. The system according to claim 16, wherein
the system further comprises a control system and a characterization apparatus; and
the control system is operatively connected to the characterization apparatus to control the latter, for the characterization apparatus to characterize one or more properties of a reaction product in the first channel, downstream of the microreactor, in operation of the system.

25. The system according to claim 16, wherein
the system further comprises a control system and a detector, the latter arranged so as to detect an electromagnetic property of at least some of the beads in the first channel, in operation; and
the control system is operatively connected to the detector for it to detect said electromagnetic property and generate a corresponding control signal.
